(19) United States
(12) Patent Application Publication
(10) Pub. No.: US 2019/0256201 A1
(43) Pub. Date: Aug. 22, 2019

(54) ROTOR ASSEMBLY WITH OVERLAPPING ROTORS

(71) Applicant: Global Energy Transmission, Co., Woodland, WA (US)

(72) Inventor: Sergey PLEKHANOV, Moscow (RU)

(21) Appl. No.: 16/141,741

(22) Filed: Sep. 25, 2018

Related U.S. Application Data
(60) Provisional application No. 62/633,003, filed on Feb. 20, 2018.

(51) Int. Cl. B64C 27/08; B64C 39/02

(52) U.S. Cl. CPC B64C 27/08; B64C 39/024; B64C 2201/066; B64C 2201/042; B64C 2201/024

(57) ABSTRACT

In some embodiments, a rotor assembly for an aerial vehicle includes a main body; and four or more rotors having blades mounted relative to the main body for rotation about respective axes configured to provide thrust predominantly in a common direction. Respective blade trajectories of rotors of at least one pair of adjacent rotors of the four or more rotors rotate in different planes. The blade trajectories of the at least one pair of adjacent rotors partially overlap when viewed along a line containing the common direction.

### CROSS REFERENCE TO RELATED APPLICATIONS

The present application claims the benefit under 35 U.S.C. § 119(e) of U.S. Provisional Patent Application Ser. No. 62/633,003, filed Feb. 20, 2018 and titled AERIAL VEHICLE WITH OVERLAPPING ROTORS, the disclosure which is hereby incorporated by reference in its entirety for all purposes.

### INTRODUCTION

The present technology is directed generally to aerial vehicles and airfoil configurations thereof and more particularly to electrically powered aerial vehicles having multiple partially overlapping rotors when viewed from a direction of thrust of the rotors.

### BACKGROUND

Aerial vehicles propelled by rotors are well known. Unmanned aerial vehicles (UAVs) propelled by rotors are becoming increasingly popular for both military and consumer functions. Due to their compact size and smooth flight, they are now used in a wide range of application areas such as surveillance and rescue operations, monitoring, security, photography, videography, parcel delivery, and transportation, to name a few. For instance, due to more fields of application of UAVs, there is an increase in the importance of enhanced travel distances and increased payload carrying capabilities of the UAVs. More power on board the UAV along with more powerful motors can provide an increased range of travel as well as an increased payload. This, however, results in significant increase in the cost, size and weight of the UAV.

Vertical take-off and landing (VTOL) aerial vehicles are also a multi-propeller form of aerial vehicle. VTOLs can be unmanned or unmanned and are usually electrically powered or have a hybrid of a: diesel or gasoline engine that produces electricity for electric motors that drive the propellers. There are versions of VTOLs that are also UAVs and can be used for many of the applications for which UAVs are used.

Accordingly, there is a need for aerial vehicles that achieve enhanced travel distance and increased payload carrying capability without significant increase in the size and weight so as to provide efficiency improvements in comparison to commonly available aerial vehicles of similar size and weight.

### SUMMARY

In some embodiments, a rotor assembly for an aerial vehicle, such as a UAV system, VTOL system, or an electrically powered aerial vehicle, includes a main body; and four or more rotors having blades mounted relative to the main body for rotation about respective axes configured to provide thrust predominantly in a common direction. Blade trajectories of rotors of at least a first pair of adjacent rotors of the four or more rotors rotate in different planes. The blade trajectories of the rotors of the at least first pair of adjacent rotors partially overlap when viewed along a line containing the common direction.

In some embodiments, a vertical take-off and landing aerial vehicle includes a main body; a rechargeable battery supported on the main body; and a rotor assembly. The rotor assembly includes four or more rotors and at least one electric motor. The four or more rotors have blades mounted relative to the main body for rotation about respective axes configured to provide thrust predominantly in a common direction. Each of the at least one electric motor is operatively coupled to the rechargeable battery for receiving electrical power for operating the at least four rotors. Blade trajectories of rotors of at least a first pair of adjacent rotors of the four or more rotors rotate in different planes. The blade trajectories of the rotors of the at least first pair of adjacent rotors partially overlap when viewed along a line containing the common direction.

In some embodiments, a UAV system, VTOL system, or an electrically powered aerial vehicle includes a main body and two or more rotors mounted on the main body. The blade trajectories of blades of at least one pair of adjacent rotors of the two or more rotors are in different planes. The different planes of the blade trajectories of the at least one pair of adjacent rotors are not orthogonal and overlap when viewed from a plane of view along an axis of one of the rotors of the at least one pair of adjacent rotors.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an example of an unmanned aerial vehicle (UAV) system;

FIG. 2 illustrates an exemplary diagram showing overlapping of blade trajectories of adjacent pair of rotors of the UAV system of FIG. 1;

FIG. 3A illustrates a schematic top view of an example of a UAV system having a pair of partially overlapping rotors;

FIG. 3B illustrates a schematic side view of the UAV system of FIG. 3A;

FIG. 4A illustrates a schematic side view of an example of a UAV system having a pair of partially overlapping rotors tilted at different angles;

FIG. 4B illustrate a schematic side view of an example of a UAV system having a pair of partially overlapping rotors tilted at a same angle;

FIG. 5 illustrates a table showing distribution of thrust produced versus power supplied for an example of a pair of non-overlapping rotors;

FIG. 6 illustrates a schematic top view of an example of overlapping of rotors for a twin-screw aerial vehicle;

FIG. 7 illustrates a table showing distribution of thrust produced versus power supplied for different values of overlapping for each motor of two overlapping rotors of an example of a UAV system; and

FIG. 8 illustrates a table showing distribution of efficiency versus overlapping for the two overlapping rotors of the UAV system of FIG. 7.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The use of overlapping rotating airfoils in aerial vehicles allows the aerial vehicle to be more compact, have less weight, and be more efficient than conventional aerial vehicles having rotors with non-overlapping airfoils, also referred to as blades or propellers that are the same size as the overlapping airfoils. The present technology is directed generally to airfoil configurations for fluid-moving apparatus, particularly aerial vehicles having two or more rotors, such as airfoils, blades, or propellers, providing propulsion or thrust in a common direction resulting from fluid movement in an opposite direction. The rotating blades or airfoils travel in blade trajectories that partially overlap when viewed along a line of the common direction of produced thrust. In the case of helicopters, the rotors may be primary or main rotors that have blades configured to sweep areas that partially overlap during rotation when viewed normal to the blade rotation. Such rotors and other configurations of rotating airfoils may be applied to aerial vehicles such as unmanned (drones) and manned helicopters, unmanned aerial vehicles (UAVs), autonomous aerial vehicles, and other rotor or propeller-driven manned aerial vehicles, as well as other apparatus providing propulsion of fluids by rotating foils.

The technology described herein may be used for constructing electrical copters (drones) having an increased efficiency factor, an increased speed (providing a decrease in flight time), increased payload carrying capability, and/or an increase in lifting capacity. The use of partially overlapping rotors may be configured to provide 1.5-1.9 times the efficiency (thrust per watt of power supplied) of the drones of the same frame size without overlapping rotors. Further, embodiments provide a rotor assembly of an aerial vehicle having reduced noise and increased payload carrying capacity for the same amount of power consumed as a conventional drone of similar size.

### Definitions

The term “aerial vehicle” may be used to refer to a rotor-propelled vehicle capable of maneuvering through a fluid medium such as air. The vehicle may be manned, unmanned, or semi-autonomous.

The term “rotor” may be used to refer to a rotating assembly including airfoils, also referred to as blades or propellers, that are capable of rotating and generating thrust. They may have a blade assembly that may be able to aerodynamically travel through the fluid medium upon rotation.

The term “thrust” may be used to refer to an propelling force, which is typically an upwardly lifting force measured in equivalents of weight that can be lifted, such as units of grams.

The term “power supply” may be used to refer to the amount of electrical power supplied to a component measured in units of watts.

The term “efficiency” may be used to refer to a measure of ability of a rotor to lift a weight per watt of power supplied and is therefore indicated in units of grams per watt.

An electrically powered aerial vehicle system and a rotor assembly thereof are provided herein in accordance with an example embodiment. The rotor assembly may have at least one pair of adjacent rotors whose blades, upon rotation, sweep areas or trajectories that partially overlap each other when viewed along a line of thrust produced by the rotors extending predominantly in a common direction. In other words, the blade trajectories of the rotors, though present in different planes, overlap partially anywhere between 10%-90%. The rotors have axes of rotation that are offset and blade trajectories in respective planes that are offset so that the blade trajectories do not intersect. Accordingly, the rotors are each located in a different plane when viewed along a plane of blade trajectory and the blade trajectories or the areas swept by the blades partially overlap when viewed along an axis of rotation of the rotor, or more generally, when viewed along a line containing a common or net direction of thrust produced by the rotors.

In some example embodiments, the rotors may each be driven by a separate electrical motor. The rotors may be any kind of rotors such as twin blade rotors, twin-screw rotors and the like. The rotors may have any suitable size as appropriate for a particular application, as long as they do not intersect each other. Similarly, the power supply and the electrical motor may be selected for a particular application. In some example embodiments, as will be discussed later, the rotors may have a radius of 11 centimeters. However, other sizes may also be used as is appropriate for a particular application. The power supply may for example be around 1-1.2 kW although any other power supply may be used depending upon the application requirements.

The aerial vehicle system may be embodied wholly or partially as any electrically powered aerial vehicle such as an unmanned aerial vehicle, a manned aerial vehicle, a vertical take-off and landing (VTOL) aerial vehicle and the like. Although embodiments herein may be described referencing an unmanned aerial vehicle, various other embodiments directed to other types of aerial vehicles are also possible within the scope of this invention.

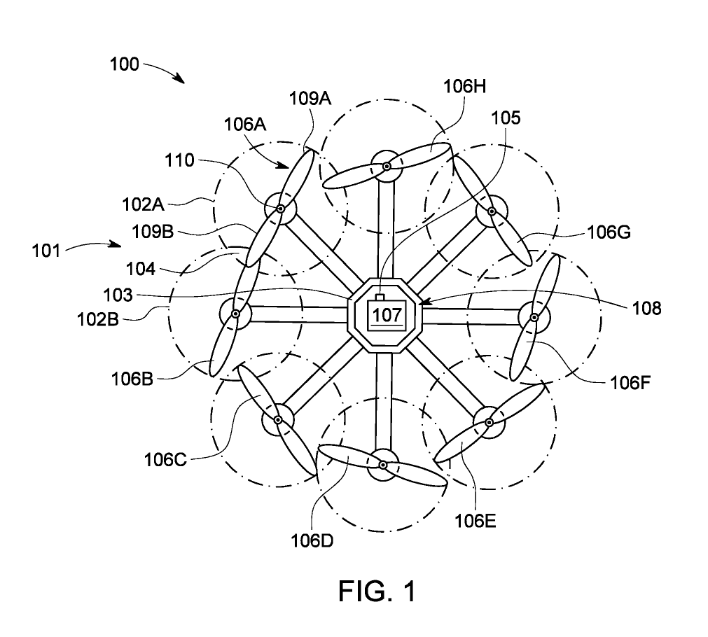

FIG. 1 illustrates an unmanned aerial vehicle (UAV) system 100, in accordance with an example embodiment. The UAV system 100 may be configured partially or wholly as an unmanned aerial vehicle. The UAV system 100 may include a rotor assembly 101 having a main body 108 and two or more rotors 106A-106H mounted on the main body. The main body 108 may comprise the main frame of the UAV system 100 and may include a fuselage 103. In some example embodiments, the main body may be configured as an octagon with eight branching arms extending from the sides of the octagon, as is shown in FIG. 1. In some example embodiments, the main body 108 may have any other suitable structure such as a rectangular frame, meshed frame, circular frame, or fuselage configured for travel in a particular direction.

In some example embodiments, the main body 108 may house the essential components of the UAV or other aerial-vehicle system such as control circuitry, power supply, such as a rechargeable battery, communication circuitry and the like. In some example embodiments, the main body 108 may include fuselage 103 for carrying payload for delivery. In some example embodiments, the main body 108 may only comprise the main frame/chassis of the UAV system 100. In some example embodiments, the rotor assembly 101 may further comprise one or more sockets 105. The one or more sockets 105 may be detachably coupled to the main frame. The one or more sockets 105 may be configured to receive interchangeable modular electronics 107, such as an image sensor and circuitry for communication with other modules or components of the aerial vehicle.

Each arm of the main body 108 may have a rotor (106A-106H) mounted on it by means of an electrically powered motor, as is shown in FIG. 1. Other configurations of arms or more generally, rotor support structures, may be used. As shown, the rotors are preferably distributed in a loop, such as a circle when viewed from the direction of thrust of the rotors. Each rotor has respective blades, such as blades 109A and 1096 of rotor 106A that rotate about a corresponding axis 110. In some example embodiments, the main body 108 may include the motors. In the scenario depicted in FIG. 1, in some example embodiments, a first set of alternate rotors (106A, 106C, 106E, 106G) around the loop of rotors may have respective blade trajectories that lie on a first common plane while a second set of rotors including the other rotors (106B, 106D, 106F, 106H), which are also alternate rotors around the loop of rotors, have respective blade trajectories that lie on a second common plane different and spaced from the first common plane. The rotors may also be supported so that the blade trajectories are on more than two levels. The blade trajectories have a radius that extends from the axis 110 to the distal end of the corresponding blade.

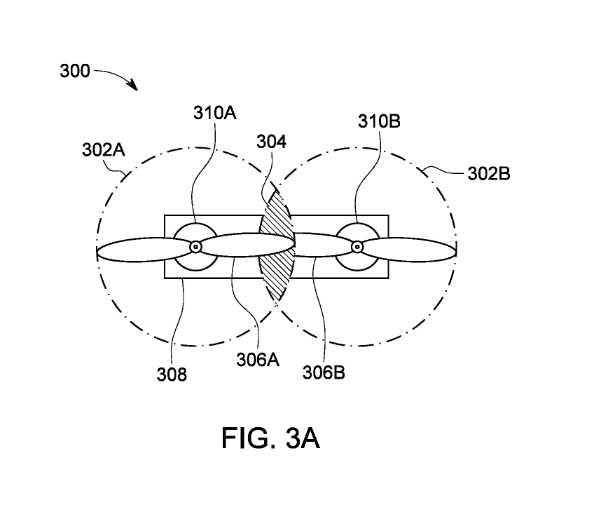

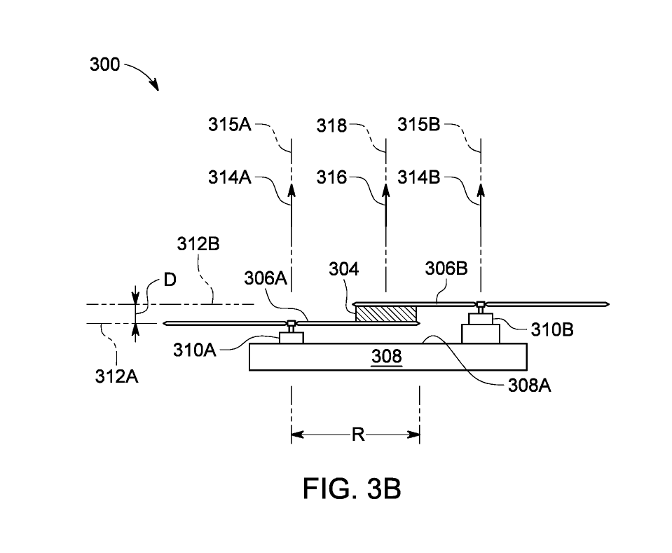

Although, eight motors and rotors are shown in FIG. 1, at least two adjacent rotors may be sufficient to describe various embodiments. Accordingly, reference will now be made to FIG. 1 considering rotors 106A and 1066. Each of the rotors 106A and 1066 sweep areas, referred to as blade trajectories 102A and 102B, respectively. The blade trajectories 102A and 102B are in different planes when viewed in a first plane of view perpendicular to the planes of the blade trajectories. (in this case the side view of FIG. 1 and shown in FIG. 3B) but overlap each other with respect to a second plane of view (in this case the plane of view of FIG. 1, which plane of view is normal to the axes of rotation). For example, the rotor 106A rotates in a plane positioned above the plane of rotation of rotor 106B and hence the two rotors rotate in different spaced-apart, parallel planes. As viewed in FIG. 1, the overlap region in which the blade trajectories 102A and 102B partially overlap is indicated as overlap region 104. In the embodiment shown in FIG. 1, each of the rotors have blade trajectories that overlap with blade trajectories of two adjacent rotors. In some example embodiments, only a portion of the rotors have blade trajectories that overlap with blade trajectories of one or more adjacent rotors. Other configurations of rotors may also be used, such as two or more sets of rotors where each rotor in a set of rotors may have overlapping blade trajectories but rotors of one set of rotors do not overlap with rotors of another set of rotors.

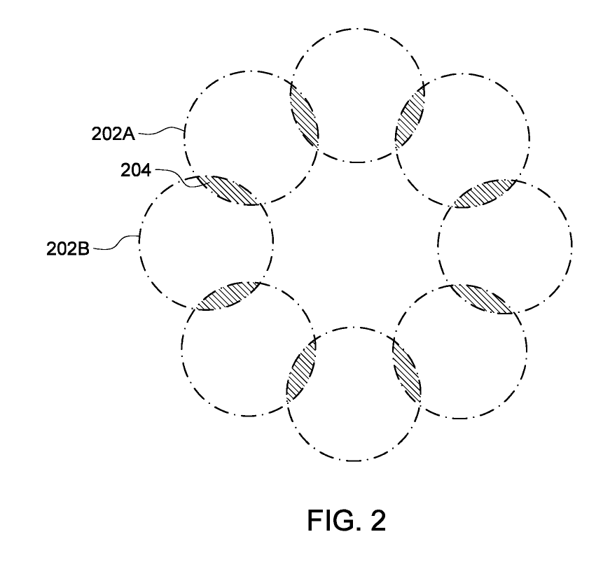

FIG. 2 illustrates an exemplary diagram showing overlapping of blade trajectories of adjacent rotors of the rotor assembly of the UAV system of FIG. 1, in accordance with an example embodiment. As is shown in FIG. 2, the blade trajectory 202A may overlap with the blade trajectory 202B in the overlap region 204 when viewed from a plane parallel to the planes of the blade trajectories. In this example the rotors produce a thrust in the direction of the viewer, which direction is along a line in the center of the rotor assembly and normal to the planes of the blade trajectories. Blade trajectories 202A and 202B correspond to the trajectories of pair of adjacent rotors (not shown in this figure). In some example embodiments, all pairs of adjacent rotors of the rotor assembly 101 may overlap as is represented by the shaded regions in FIG. 2. The degree of overlap of the planes of the blade trajectories may be greater than or equal to 10% and less than or equal to 90% of the area swept by the rotors.

FIG. 3A illustrates a schematic top view of a rotor assembly 300 of an aerial vehicle having a pair of adjacent, partially overlapping rotors, in accordance with an example embodiment. The rotor assembly 300 may comprise a main body 308 housing a pair of motors 310A and 310B. The axes of rotation shafts of the pair of motors 310A and 310B may be parallel. The rotor assembly 300 may further comprise a pair of rotors 306A and 306B having blade trajectories 302A and 302B, respectively. In examples in which the rotors rotate in horizontal planes, rotor 306A may be at a higher elevation from the main body 308 in comparison to the rotor 306B and therefore may partially block the rotor 306B from the view shown in FIG. 3A when the blades are aligned. The blade trajectories 302A and 302B may partially overlap in the region 304 shown as shaded. The motor 310A may drive the rotor 306A while the motor 310B may drive the rotor 306B such that the two sweep the areas 302A and 302B respectively. As is shown in the schematic top view of FIG. 3A, the swept areas/blade trajectories 302A and 302B overlap in region 304.

FIG. 3B illustrates a schematic side view of the rotor assembly 300 of FIG. 3A. The fact that rotor 306A, having a blade trajectory in a plane 312A, is at a higher height in comparison to the rotor 306B, having a blade trajectory in a plane 312B, is illustrated in the side view shown in FIG. 3B. In this example, plane 312A is parallel to and spaced a distance D from plane 312B. A significant reduction in noise may be achieved if the planes of overlapping blade trajectories are separated by a distance D equal to or less than one half of the blade radius R. The overlap region 304 is thus the common region between the swept areas 302A and 302B of FIG. 3A. Further, in some example embodiments, the plane of rotation of the rotors 306A and 306B may be in different planes, as is shown in FIG. 3B. In some example embodiments, the blades of the rotors 306A and 306B may be long enough to overlap to the extent of 50% or more of the blade radius R. A bigger radius of the swept area (i.e. the bigger the corresponding extent of overlapping) results in a lower rotation rate required to produce the same force of propulsion, which correspondingly results in better blade efficiency and less noise. The increase of swept area requires less energy to produce the same lifting force, so the efficiency of the system is higher.

In this example, each rotor 306A, 306B produces a rotor thrust in a direction represented by respective arrow 314A, 314B, which is aligned with the respective rotor axis of rotation 315A, 315B. The rotor assembly thereby produces a combined thrust in a common direction represented by arrow 316 extending along a line 318. The individual rotor thrusts are predominantly along the direction of arrow 316, since arrows 314A, 314B are parallel to the direction of the combined thrust in the direction of arrow 316. The extent of overlapping region 304 is determined as blade trajectories 306A and 306B are viewed from along line 318. FIG. 3A is an example of such a view.

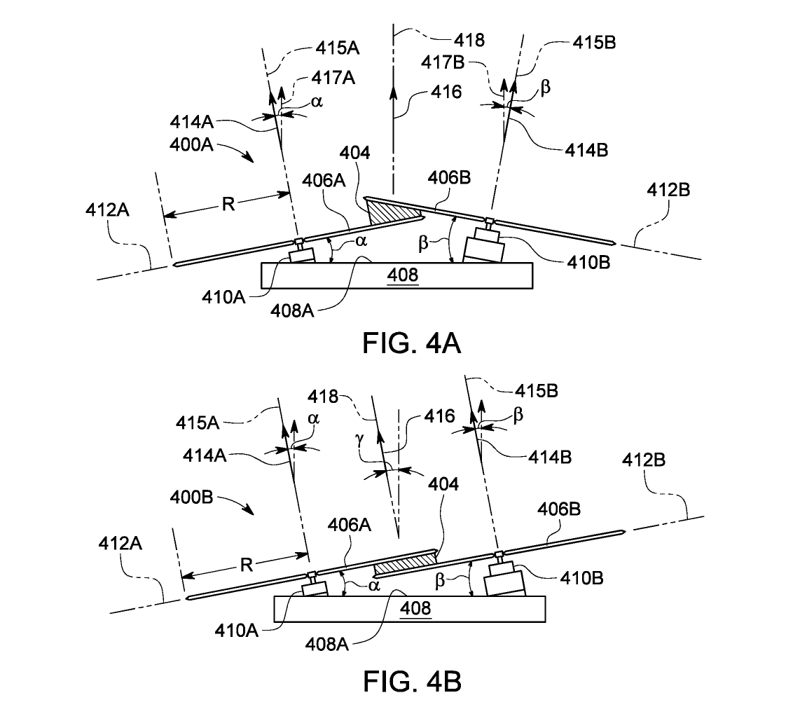

Although, FIG. 3B illustrates that the rotors 306A and 306B lie parallel to a horizontal, upper surface 308A of the main body 308, in some example embodiments they may be inclined with respect to the main body 308. FIG. 4A illustrates a schematic side view of a rotor assembly 400A having a pair of partially overlapping rotors 406A and 406B tilted at different angles in opposite directions from vertical. As illustrated, line 418 is a vertical line that is perpendicular to a horizontal surface 408A of the main body 408, according to an example embodiment. The rotation shafts of the motors 410A and 410B may be inclined to rotate about respective axes 415A and 415B at different non-vertical angles α, β with respect to vertical line 418. The blade trajectories of rotors 406A and 406B extend in respective planes 412A and 412B.

During rotation, rotors 406A and 406B may produce individual thrusts in directions represented by arrows 414A and 414B that extend along axes 415A and 415B, respectively. A combined thrust in a direction represented by arrow 416 results from the individual thrusts. In the example shown, arrow 414A is an angle α from the direction of arrow 416 and arrow 414B is an angle β from the direction of arrow 416. These angles are represented by the angles between arrows 414A and 414B relative to component arrows 417A and 417B, shown in dashed lines, that are in alignment with (parallel to) arrow 416 representing the combined thrust. The individual thrusts represented by arrows 414A and 414B can be seen to be directed predominantly (i.e., more than half in magnitude) in the direction represented by arrow 416.

In an example in which angle α equals angle β, arrow 416 representing the combined thrust is in a vertical direction and line 418 is a vertical line. In examples where angle α does not equal angle β, then arrow 416 will extend along a line that varies from vertical. The direction of arrow 16 thus depends both on angles α and β, but also on the configuration and relative rotational speeds of rotors 406A and 406B. In other words, the direction and magnitude of combined thrust represented by arrow 416 depends on the directions and magnitudes of the individual thrusts represented by arrows 414A and 414B.

In some example embodiments, due to the inclination of the rotation shaft of the motor 410A, the rotor 406A may be inclined at an angle α with respect to the base of the main body 408. Similarly, due to the inclination of the rotation shaft of motor 410B, the rotor 406B may be inclined at an angle β with respect to the base of the main body 408, represented by horizontal surface 408A. Accordingly, the plane 412A in which the blade trajectory of the rotor 406A lies, is inclined at the angle α with respect to the base of the main body 408, while the plane 412B in which the blade trajectory of the rotor 406B lies is inclined at the angle β with respect to the base of the main body 408.

FIG. 4B illustrate a schematic side view of a rotor assembly 400B having a pair of partially overlapping rotors 406A and 406B tilted at respective angles α, β in the same direction from vertical, according to an example embodiment. For ease of understanding, the same reference numbers are used in FIG. 4B as in FIG. 4A with the understanding that angle β is in a reverse direction from vertical compared to the illustration in FIG. 4A. In some example embodiments, rotation shafts of the motors 410A and 410B may be inclined at angles α, β in the same direction from vertical with respect to horizontal upper surface 408A of the main body 408. Accordingly, the planes 412A and 412B in which the blade trajectories of the rotors 406A and 406B lie are also inclined at respective angles α, β with respect to the base of the main body. Thrust directions represented by arrows 414A, 414B, and 416 extend at respective angles α, 13, and γ (gamma) from vertical. The angle γ of the combined thrust extends along a line 418 the position, magnitude, and angle depending on the relative position, magnitude, and angle of the individual rotor thrusts, as discussed previously. It will be appreciated that the individual thrusts will extend predominantly in the common direction represented by arrow 416 extending along line 418 at angle γ. The amount of overlap 404 of blade trajectories may be determined when the blade trajectories are viewed along line 418. In an example as illustrated in FIG. 4B, individual rotor thrusts represented by arrows 414A and 414B are equal and angles α and β are equal, resulting in angle γ being equal to angles α and β. It will be appreciated that this is a special case that depends on such equalities. When one or more of these equalities do not exist, then the positions, magnitudes, and directions of the thrusts will vary.

In some example embodiments, the blade radius R of each of the rotors 406A and 406B of FIGS. 4A and 4B may be the same. For example, the blade radius may be 11 centimeters or another size appropriate for a particular application. In some example embodiments, the centers of the rotors 406A and 406B of FIGS. 4A and 4B through which axes 415A and 415B extend may be spaced at a distance equal to half of the blade radius of the rotors 406A and 406B.

Many advantageous effects of the present invention will become apparent through the following description of the experimental data obtained.

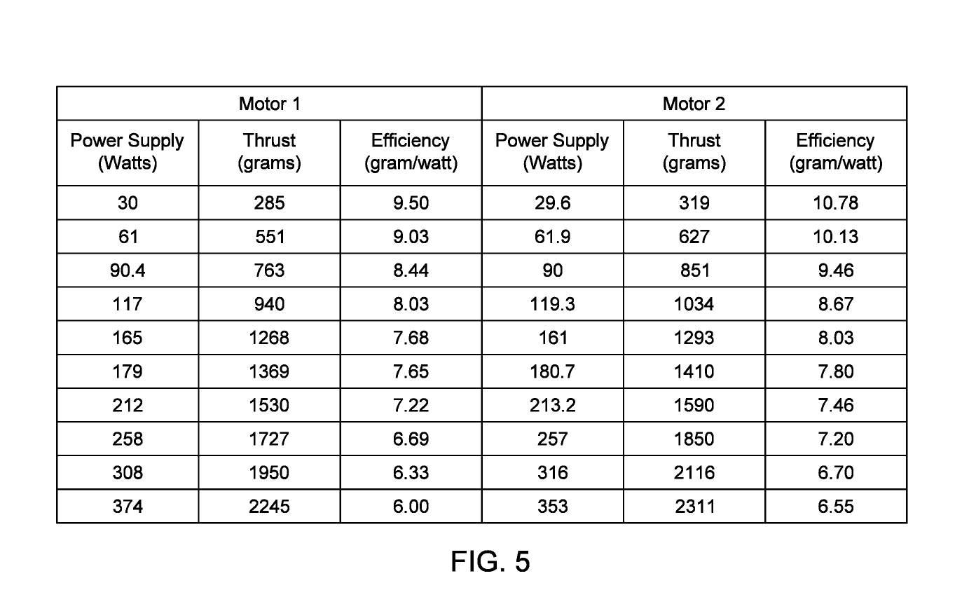

FIG. 5 illustrates a table showing distribution of thrust produced versus power supplied for a pair of non-overlapping rotors of a rotor assembly of a conventional UAV system. The efficiency, (grams of thrust per watt of applied power) is shown for each power level applied. The data tabulated in FIG. 5 serves as base data for further comparison with data for overlapping rotors. In this example, the two rotors were the same size and shape.

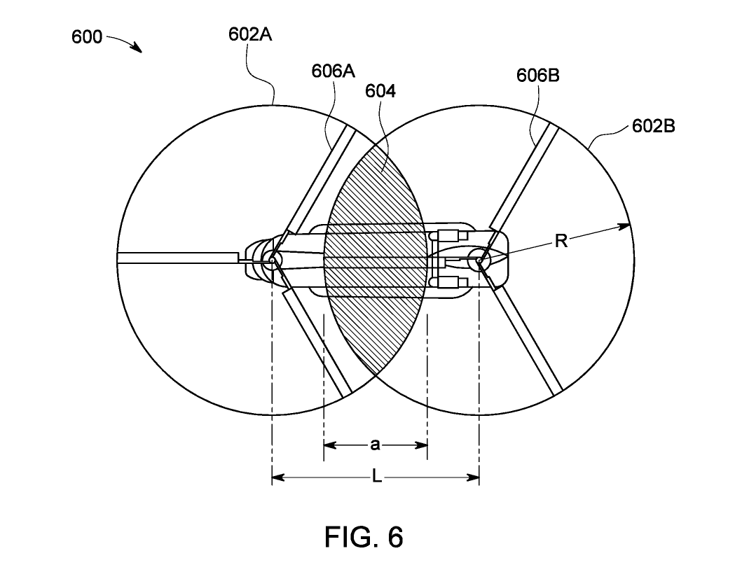

FIG. 6 illustrates a schematic top view of overlapping of rotors for a twin-screw aerial vehicle 600, according to an example embodiment. In some example embodiments, the overlapped swept area 604 if properly adjusted, provides higher lifting force compared to non-overlapped rotors of the same size. The rotors 606A and 606B may be considered to have the same dimensions and shape, and thus blade trajectories 602A and 602B having the same blade radius R. The following description uses the following variables:

S—swept area of the blade trajectory of the blades of a single rotor (606A or 606B),

A—area of overlap of rotor blades (indicated as shaded region 604),

R—radius of swept area and length of rotor blades from the axis of rotation,

L—distance between axes of rotation of two adjacent rotors' bushings (rotors 606A and 606B), and

a—depth of overlap measured along a line between the two axes of rotation (i.e. 2R-L).

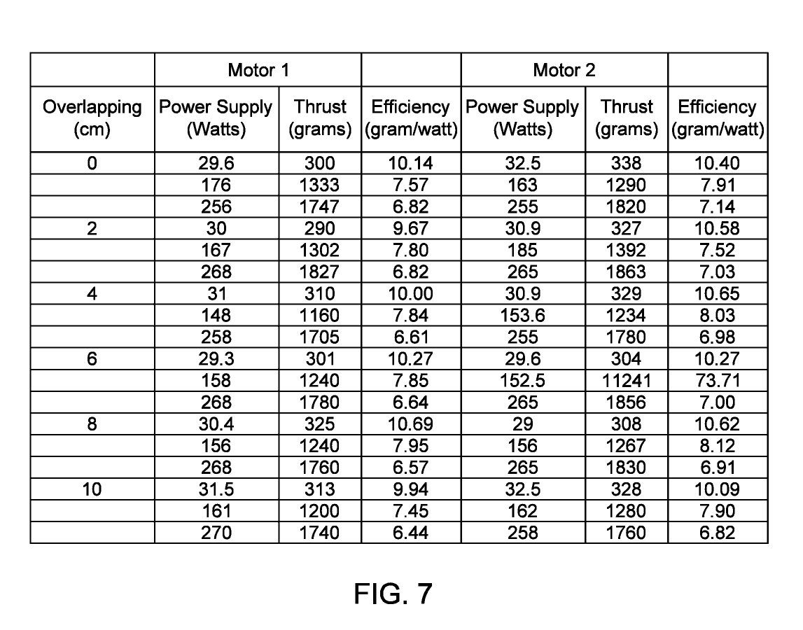

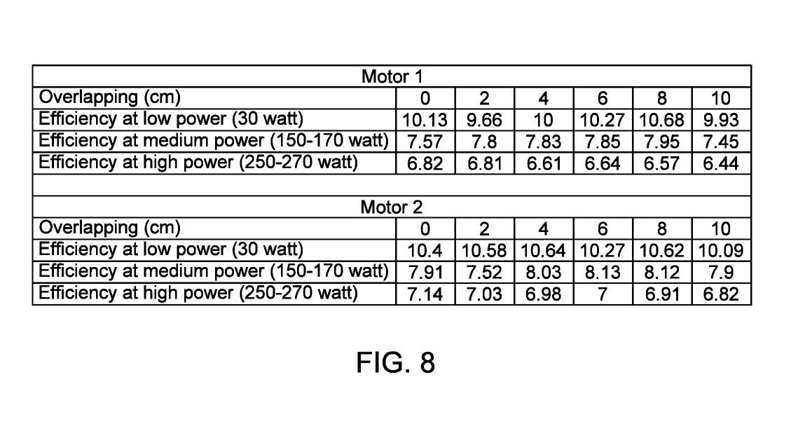

Rotor overlapping, i.e., when a>0, may exist when rotor 606A is positioned with blades at a height above the blades of rotor 606B and L is less than 2R. In some example embodiments, the rotors 606A and 606B may be connected to parallel shafts. As is shown in the tables shown in FIGS. 7 and 8, experimental data confirms that when swept areas of rotors 606A and 606B are partially overlapped the total lifting force increases by a factor of k(a), where k is a coefficient greater than one, k being a function of a, the extent of partial overlap, and the speed of rotation, in comparison with non-overlapping rotors. The percent of overlap (a/R) is not given. However, it can be determined from the length of overlap, as given in centimeters in FIGS. 7 and 8, and the radius R of the blades, which was 18 centimeters.

Lifting forces F1 and F2 may be defined as follows:

F1—lifting force of a non-overlapping system with two rotors where L>=2R and the overall swept area S1=2*S, and

F2—lifting force of a system with two partially overlapping rotors where R<L<2R (see FIG. 5), having an overall swept area S2=2*S−A.

FIG. 7 is a table showing the distribution of thrust produced versus power supplied for different values of overlapping for each motor of two overlapping rotors 606A and 606B of the UAV system 600 of FIG. 6, in accordance with an example embodiment. Each series of measurements made is for a certain value of overlapping (from 0 to 10 cm, in 2 cm increments). Three different power supply levels are used in each series of measurements.

FIG. 8 is a table showing the distribution of efficiency versus overlapping for the two overlapping rotors of the UAV system of FIG. 6, according to an example embodiment. The table of FIG. 8 demonstrates an increase of total system efficiency (thrust level) with increase in overlapping for lower and medium power supply levels for overlapping from 2 to 8 cm. Increase in overlapping beyond a critical overlapping level of 10 cm, results in a drop in efficiency.

The data shown in FIGS. 7 and 8 indicate that F2>=F1, even though S2<S1. Additionally, F2 increases as long as ‘a’ increases until a maximum value of F2max achieved at amax, beyond which a further increase of the extent a of overlap results in a reduction of F2. In general, it is found that efficiency is improved where the degree of overlap of the blade trajectories is greater than or equal to 10% and less than or equal to 90% when viewed along the line containing the common direction.

In this prototype a rotor assembly having 22 inches in diameter propellers were overlapped over 50% of the blade radius R of 11 inches. It produced 50% to 90% (1.5-1.9 times) increase in efficiency for the common drone without overlapping of the same size of wheel base and weight. Particularly, if standard (non-overlapped) propellers are used, this rotor assembly requires 2-2.2 kW of power to keep hovering at total weight of 11-12 kg. With rotor overlapping, the rotor assembly for the same size of wheel base requires only 1.1-1.2 kW of power for the same weight. For this example, then, a rotor assembly with overlapping rotors could travel almost double the distance, or could carry almost twice the payload as a rotor assembly without overlapping rotors. Rotor overlapping allows the use of longer rotors for rotors having the same rotation shaft positions and therefore slightly increases the outer physical dimension of the vehicle, while keeping the same size of wheel base. Usage of overlapping of rotors means increased size of the propellers which means decreased speed of rotation of the propellers for the same thrust which means decrease in noise level. Also additional significant reduction in noise is achieved if the planes of overlapping blade trajectories are separated by a distance equal to or less than one half of the blade radius.

From the above description, it will be appreciated that many variations are possible in a wireless power transfer system. The following numbered paragraphs describe aspects and features of embodiments. Each of these paragraphs can be combined with one or more other paragraphs, and/or with disclosure from elsewhere in this application in any suitable manner. Some of the paragraphs below expressly refer to and further limit other paragraphs, providing without limitation examples of some of the suitable combinations.

1. A rotor assembly for an aerial vehicle, comprising a main body; and four or more rotors having blades mounted relative to the main body for rotation about respective axes configured to provide thrust predominantly in a common direction, wherein blade trajectories of rotors of at least a first pair of adjacent rotors of the four or more rotors rotate in different planes, and wherein the blade trajectories of the rotors of the at least first pair of adjacent rotors partially overlap when viewed along a line containing the common direction.

2. The rotor assembly of point 1, wherein a degree of overlap of the blade trajectories is greater than or equal to 10% of the radius of one of the overlapping blade trajectories and less than or equal to 90% of the radius of the one blade trajectory when viewed along the line containing the common direction.

3. The rotor assembly of point 1, wherein the axes of rotation of the rotors of each pair of overlapping adjacent rotors are parallel.

4. The rotor assembly of point 1, wherein the axes of rotation of the rotors of each pair of overlapping adjacent rotors are parallel to the line containing the common direction.

5. The rotor assembly of point 1, wherein the planes of the blade trajectories of the rotors of each pair of adjacent rotors are non-parallel and the blade trajectories are non-intersecting.

6. The rotor assembly of point 1, wherein the axes of rotation of the rotors of at least one pair of overlapping adjacent rotors are parallel and disposed at a transverse angle relative to the common direction.

7. The rotor assembly of point 1, wherein the blade trajectories of the rotors of each pair of overlapping adjacent rotors have a same trajectory radius, and the axes of rotation of the rotors of each pair of overlapping adjacent rotors are spaced at a distance that is half of the trajectory radius.

8. The rotor assembly of point 7, wherein a degree of overlap of the blade trajectories is greater than or equal to 50% of the trajectory radius of one of the blade trajectories of the at least first pair of adjacent rotors.

9. The rotor assembly of point 1, wherein each pair of adjacent rotors of the four or more rotors partially overlap when viewed along the line containing the common direction, and the four or more rotors are distributed about a loop when viewed along a line of combined thrust of the four or more rotors, and planes of blade trajectories of a first set of alternate rotors around the loop are in a first common plane and planes of blade trajectories of a second set of rotors not in the first set of rotors are in a second common plane spaced from the first common plane.

10. The rotor assembly of point 1, further comprising at least one socket coupled to the main body, wherein the at least one socket is configured to receive an interchangeable modular electronics unit including an image sensor and circuitry for communications with other components of the aerial vehicle.

11. The rotor assembly of any of points 1 to 10, wherein the main body includes a fuselage.

12. The rotor assembly of any of points 1 to 11, where the aerial vehicle is an electrical drone.

13. The rotor assembly of any of points 1 to 12, where the aerial vehicle is an electrical Vertical Take-Off and Landing (VTOL) vehicle.

14. The rotor assembly of any of points 1 to 8 and 10 to 13, wherein each rotor of the four or more rotors has a blade trajectory that overlaps with blade trajectories of at least two other rotors of the four or more rotors.

15. An unmanned aerial vehicle comprising the rotor assembly of any of points 1 to 12 and 14, wherein the rotor assembly includes at least one electric motor for operating the at least four rotors, the unmanned aerial vehicle further including a rechargeable battery operatively coupled to the at least one electric motor for powering the at least one electric motor.

16. A vertical take-off and landing aerial vehicle comprising:

a main body;
a rechargeable battery supported on the main body; and
a rotor assembly including:

four or more rotors having blades mounted relative to the main body for rotation about respective axes configured to provide thrust predominantly in a common direction, and

at least one electric motor for operating the at least four rotors, each at least one electric motor being operatively coupled to the rechargeable battery for receiving electrical power;

wherein blade trajectories of rotors of at least a first pair of adjacent rotors of the four or more rotors rotate in different planes, and

wherein the blade trajectories of the rotors of the at least first pair of adjacent rotors partially overlap when viewed along a line containing the common direction.

17. The vertical take-off and landing aerial vehicle of point 16, wherein a degree of overlap of the blade trajectories is greater than or equal to 10% of a radius of one of the overlapping blade trajectories of the rotors of each pair of adjacent rotors and less than or equal to 90% of the radius of the one blade trajectory when viewed along the line containing the common direction.

18. The vertical take-off and landing aerial vehicle of point 16, wherein the axes of rotation of the rotors of each pair of overlapping adjacent rotors are parallel.

19. The vertical take-off and landing aerial vehicle of point 18, wherein the axes of rotation of the rotors of each pair of overlapping adjacent rotors are parallel to the line containing the common direction.

20. The vertical take-off and landing aerial vehicle of point 16, wherein the planes of the blade trajectories of the rotors of at least one pair of overlapping adjacent rotors are non-parallel and the blade trajectories are non-intersecting.

21. The vertical take-off and landing aerial vehicle of point 16, wherein the axes of rotation of the rotors of at least one pair of overlapping adjacent rotors are parallel and disposed at a transverse angle relative to the common direction.

22. The vertical take-off and landing aerial vehicle of point 16, wherein the blade trajectories of the rotors of each pair of overlapping adjacent rotors have a same trajectory radius, and the axes of rotation of the rotors of each pair of overlapping adjacent rotors are spaced at a distance that is half of the trajectory radius.

23. The vertical take-off and landing aerial vehicle of point 22, wherein a degree of overlap of the blade trajectories is greater than or equal to 50% of the trajectory radius of one of the blade trajectories of the at least first pair of adjacent rotors.

24. The vertical take-off and landing aerial vehicle of point 16, wherein each pair of adjacent rotors of the four or more rotors partially overlap when viewed along the line containing the common direction, and the four or more rotors are distributed about a loop when viewed along a line of combined thrust of the four or more rotors, and planes of blade trajectories of a first set of alternate rotors around the loop are in a same first common plane and planes of blade trajectories of a second set of rotors not in the first set of rotors are in a second common plane spaced from the first common plane.

25. The vertical take-off and landing aerial vehicle of point 16, wherein each rotor of the four or more rotors has a blade trajectory that overlaps with two other rotors of the four or more rotors.

26. The vertical take-off and landing aerial vehicle of point 16, further comprising at least one socket coupled to the main body, wherein the at least one socket is configured to receive an interchangeable modular electronics unit including an image sensor and circuitry for communications with other components of the aerial vehicle.

27. The vertical take-off and landing aerial vehicle of point 16, wherein the main body includes a fuselage.

The use of overlapping rotating airfoils enables aerial vehicles to be made that are more compact, have less weight, and are more efficient than conventional aerial vehicles having non-overlapping blades or airfoils, such as rotors and propellers, that are the same size as the overlapping airfoils. Therefore, this described technology may be used for constructing electrical copters (drones) that have an increase in efficiency factor, an increase in speed providing a decrease in flight time, an increase in payload, and/or an increase in lifting capacity. These benefits may provide new areas of aerial vehicle use, including new applications for electrical copters (drones). Such drones can be used for payload delivery, video recording, passenger and urban transportation, rescue missions, and other applications where large and powerful drones can be utilized.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A rotor assembly for an aerial vehicle, comprising:
a main body; and
four or more rotors having blades mounted relative to the main body for rotation about respective axes configured to provide thrust predominantly in a common direction,
wherein blade trajectories of rotors of at least a first pair of adjacent rotors of the four or more rotors rotate in different planes,
wherein the blade trajectories of the rotors of the at least first pair of adjacent rotors partially overlap when viewed along a line containing the common direction, and
wherein a degree of overlap of the blade trajectories is greater than or equal to 10% of a radius of one of the overlapping blade trajectories and less than or equal to 90% of the radius of the one blade trajectory when viewed along the line containing the common direction.

2. (canceled)

3. The rotor assembly of claim 1, wherein the axes of rotation of the rotors of each pair of overlapping adjacent rotors are parallel.

4. The rotor assembly of claim 3, wherein the axes of rotation of the rotors of each pair of overlapping adjacent rotors are parallel to the line containing the common direction.

5. The rotor assembly of claim 1, wherein the planes of the blade trajectories of the rotors of at least one pair of overlapping adjacent rotors are non-parallel and the blade trajectories are non-intersecting.

6. The rotor assembly of claim 1, wherein the axes of rotation of the rotors of at least one pair of overlapping adjacent rotors are parallel and disposed at a transverse angle relative to the common direction.

7. The rotor assembly of claim 1, wherein the blade trajectories of the rotors of each pair of overlapping adjacent rotors have a same trajectory radius, and the axes of rotation of the rotors of each pair of overlapping adjacent rotors are spaced at a distance that results in a degree of overlap of the blade trajectories that is half of the trajectory radius.

8. The rotor assembly of claim 1, wherein a degree of overlap of the blade trajectories is greater than or equal to 50% of the trajectory radius of one of the blade trajectories of the at least first pair of adjacent rotors.

9. The rotor assembly of claim 1, wherein each pair of adjacent rotors of the four or more rotors partially overlap when viewed along the line containing the common direction, and the four or more rotors are distributed about a loop when viewed along a line of combined thrust of the four or more rotors, and planes of blade trajectories of a first set of alternate rotors around the loop are in a same first common plane and planes of blade trajectories of a second set of rotors not in the first set of rotors are in a second common plane spaced from the first common plane.

10. The rotor assembly of claim 1, wherein each rotor of the four or more rotors has a blade trajectory that overlaps with the blade trajectories of at least two other rotors of the four or more rotors.

11. The rotor assembly of claim 1, further comprising at least one socket coupled to the main body, wherein the at least one socket is configured to receive an interchangeable modular electronics unit including an image sensor and circuitry for communications with other components of the aerial vehicle.

12. The rotor assembly of claim 1, wherein the main body includes a fuselage.

13. An unmanned aerial vehicle comprising the rotor assembly of claim 1, wherein the rotor assembly includes at least one electric motor for operating the at least four rotors, the unmanned aerial vehicle further including a rechargeable battery operatively coupled to the at least one electric motor for powering the at least one electric motor.

14. A vertical take-off and landing aerial vehicle comprising:
a main body;
a rechargeable battery supported on the main body; and
a rotor assembly including
four or more rotors having blades mounted relative to the main body for rotation about respective axes configured to provide thrust predominantly in a common direction, and
at least one electric motor for operating the at least four rotors, wherein each at least one electric motor is operatively coupled to the rechargeable battery for receiving electrical power;
wherein blade trajectories of rotors of at least a first pair of adjacent rotors of the four or more rotors rotate in different planes, and
wherein the blade trajectories of the rotors of the at least first pair of adjacent rotors partially overlap when viewed along a line containing the common direction.

15. The vertical take-off and landing aerial vehicle of claim 14, wherein a degree of overlap of the blade trajectories is greater than or equal to 10% of a radius of one of the overlapping blade trajectories of the rotors of each pair of adjacent rotors and less than or equal to 90% of the radius of the one blade trajectory when viewed along the line containing the common direction.

16. The vertical take-off and landing aerial vehicle of claim 14, wherein the axes of rotation of the rotors of each pair of overlapping adjacent rotors are parallel.

17. The vertical take-off and landing aerial vehicle of claim 16, wherein the axes of rotation of the rotors of each pair of overlapping adjacent rotors are parallel to the line containing the common direction.

18. The vertical take-off and landing aerial vehicle of claim 14, wherein the planes of the blade trajectories of the rotors of at least one pair of overlapping adjacent rotors are non-parallel and the blade trajectories are non-intersecting.

19. The vertical take-off and landing aerial vehicle of claim 14, wherein the axes of rotation of the rotors of at least one pair of overlapping adjacent rotors are parallel and disposed at a transverse angle relative to the common direction.

20. The vertical take-off and landing aerial vehicle of claim 14, wherein the blade trajectories of the rotors of each pair of overlapping adjacent rotors have a same trajectory radius, and the axes of rotation of the rotors of each pair of overlapping adjacent rotors are spaced at a distance that is half of the trajectory radius.

21. The vertical take-off and landing aerial vehicle of claim 20, wherein a degree of overlap of the blade trajectories is greater than or equal to 50% of the trajectory radius of one of the blade trajectories of the at least first pair of adjacent rotors.

22. The vertical take-off and landing aerial vehicle of claim 14, wherein each pair of adjacent rotors of the four or more rotors partially overlap when viewed along the line containing the common direction, and the four or more rotors are distributed about a loop when viewed along a line of combined thrust of the four or more rotors, and planes of blade trajectories of a first set of alternate rotors around the loop are in a same first common plane and planes of blade trajectories of a second set of rotors not in the first set of rotors are in a second common plane spaced from the first common plane.

23. The vertical take-off and landing aerial vehicle of claim 14, wherein each rotor of the four or more rotors has a blade trajectory that overlaps with the blade trajectories of two other rotors of the four or more rotors.

24. The vertical take-off and landing aerial vehicle of claim 14, further comprising at least one socket coupled to the main body, wherein the at least one socket is configured to receive an interchangeable modular electronics unit including an image sensor and circuitry for communications with other components of the aerial vehicle.

25. The vertical take-off and landing aerial vehicle of claim 14, wherein the main body includes a fuselage.
